(19) United States
(12) Patent Application Publication
(10) Pub. No.: US 2008/0136180 A1
(43) Pub. Date: Jun. 12, 2008

(54) FITTING FOR A PIPE, IN PARTICULAR A PLASTIC PIPE OR A PLASTIC-METAL COMPOSITE PIPE

(75) Inventor: Rainer Dittmar, Uechtelhausen (DE)

Correspondence Address: SHUMAKER & SIEFFERT, P. A., 1625 RADIO DRIVE, SUITE 300, WOODBURY, MN, 55125, US

(73) Assignee: Uponor Innovation AB, Fristad (SE)

(21) Appl. No.: 11/948,257

(22) Filed: Nov. 30, 2007

(30) Foreign Application Priority Data
Dec. 6, 2006 (EP) 06 125 526.1

(51) Int. Cl. F16B 4/00; F16L 25/00

(52) U.S. Cl. 285/381.2; 285/381.1

(57) ABSTRACT

A fitting for a pipe, in particular a plastic pipe or a plastic-metal composite pipe, is provided with a fitting body (12) for receiving an end (24) of a pipe (26) to be connected and a fixing element (32) for fixing said end (24) of said pipe (26) to be connected to said fitting body (12), wherein said fixing element (32) comprises a shape memory metal alloy, and said fixing element (32) is deformable by thermal activation from a non-fixing state in which said end (24) of said pipe (26) to be connected, is received by said fitting body (12) without being fixed, into a fixing state in which said end (24) of said pipe (26) to be connected is fixed to said fitting body (12).

### RELATED FOREIGN APPLICATION

The present application claims the priority of European Patent Application No. EP 06 125 526.1, the disclosure of which is herewith incorporated herein by reference.

### BACKGROUND OF THE INVENTION

1. Field of the invention

The invention relates to a fitting for a pipe which is in particular a plastic pipe or a plastic-metal composite pipe.

2. Description of related art

Fittings for plastic pipes or plastic-metal composite pipes are generally known. Normally, the fittings comprise a fitting body provided with a supporting sleeve onto which the end of a pipe to be connected is adapted to be slid. Further, the known fitting bodies are provided with compression elements adapted to fix the end of the pipe to be connected to the supporting sleeve. Examples of such fittings, which are sometimes referred to as compression fittings, are described in DE-A-199 34 093, DE-U-93 15 601, DE-U-203 13 506, WO-A-2006/097409, U.S. Pat. No. 3,830,531, EP-A-0 004 686, U.S. Pat. No. 4,934,743 and JP-A-60-81572.

In the known compression fittings, the compression force to be exerted by the compression element to the pipe to be connected is produced by radially inwardly directed compression and/or constriction of a compression ring. For this purpose, a cap nut surrounding the compression ring is tightened, said tightening representing an additional work step.

From EP 0 682 758 B1 it is known to press or compress the end of the pipe to be connected, which is slid on the supporting sleeve, against the supporting sleeve with the aid of a pre-expanded plastic sleeve. The installation of such a fitting is also relatively time-consuming.

Further, from EP-A-0 296 003 it is known to generally use, besides a plastically deformed press-on element, such as a press sleeve, a press-on element made of a shape memory alloy. Such shape memory alloys can be transferred into one of two crystal states by mechanical deformation, which takes place during cold forming of the element made of a shape memory alloy. This type of deformation is performed below the martensite start temperature specific to the alloy in a low temperature phase. The recovery of the original shape takes place automatically when the shape memory alloy is heated to a temperature exceeding its austenite start temperature.

### SUMMARY OF THE INVENTION

It is an object of the present invention to provide a fitting for a pipe, in particular a plastic pipe or a plastic-metal composite pipe, wherein a fixing element clamped to the pipe to be connected can be activated in a simple manner.

The present invention suggests a fitting for a pipe, in particular a plastic pipe or a plastic-metal composite pipe, wherein the fitting is provided with
a fitting body for receiving an end of a pipe to be connected, and
a fixing element for fixing the end of the pipe to be connected to the fitting body.

According to the present invention, it is provided that in the fitting
the fixing element comprises a shape memory metal alloy, and
the fixing element is adapted to be deformed by thermal activation from a non-fixing state in which the end of the pipe to be connected is received by the fitting body without being fixed, into a fixing state in which the end of the pipe to be connected is fixed to the fixing body.

According to the present invention, the fixing element comprises a metal alloy, namely a shape memory metal alloy. Such alloys are adapted to be optionally converted by thermal influencing into the martensite structural state (soft phase) and into the austenite structural state (hard phase). The fixing element made of this material is first deformed (in particular cold formed below its martensite start temperature) and transferred into a non-fixing state in which the end of the pipe to be connected is adapted to be slid onto the supporting sleeve without being fixed. When the fixing element is thermally activated, i.e. heated to a temperature above its austenite start temperature, it is transferred into its fixing state in which the end of the pipe to be connected is fixed to the supporting sleeve. In its state before cold forming, the fixing element has a shape which essentially equals the shape of the fixing element in its fixing state.

According to the present invention, a shape memory metal alloy is used for the fixing element. Such metal alloys are known, and they are sold by Dr.-Ing. Mertmann Memory-Metalle GmbH, 79098 Freiburg i.Br., Germany, for example. The martensite and austenite start temperatures can be defined by selection of the alloy composition. In a fitting the austenite start temperature, i.e. the temperature at which the fixing element returns into its original shape, should lie above approximately 60° and range between 60° and 100° for preventing inadvertent thermal activation of the fixing element.

The fixing element according to the present invention made of a shape memory metal alloy can be used without, in its fixing state, deforming the end of the pipe to be connected. For example, the fixing element may be in abutment to the outside or the inside of the pipe to be connected and/or cling thereto for preventing inadvertent detachment of the pipe from the fitting. Such locking mechanisms are known to be used in plug-in fittings. However, it is also possible that the force applied by the fixing element in its fixing state to the end of the pipe to be connected causes the pipe end to deform, which deformation can be utilized for fixing the pipe end to the fitting body. In this variant of the present invention, the fitting body comprises a supporting sleeve onto which the end of the pipe to be connected is adapted to be slid. The supporting sleeve may comprise a recess at its outside, into which the fixing element spanning said recess presses the pipe end to be connected, thereby deforming said pipe end. Further, it is possible that the supporting sleeve comprises a projection at its outside, wherein the fixing element in its fixing state presses a projection-spanning portion of the end of the pipe to be connected against the supporting sleeve, thereby deforming the pipe, said pressing occurring at least on the side of the projection facing away from a free end of the supporting sleeve via which the pipe to be connected is adapted to be slid onto the supporting sleeve. Further, due to the deformation of the pipe, the pipe may be sealed at the fitting body. This type of sealing is however not absolutely necessary since sealing of the pipe, which is normally effected via elastomeric sealing elements, may also be realized in a region outside the deformation region of the pipe end to be connected.

The fixing element is preferably supported by a holding element surrounding the pipe end received by the fitting body. If the fitting body is provided with a supporting sleeve, said supporting sleeve and the holding element are arranged essentially concentrically with each other, wherein the end of the pipe to be connected extends between the two components. In its fixing state, the fixing element is supported by the holding element, thus reliably engaging the end of the pipe to be connected for the purpose of fixing said end.

Preferably, the fixing element is a fixing ring. Accordingly, the projection and/or the recess of the supporting sleeve, which are described above in conjunction with individual aspects of the present invention, extend in circumferential direction of the supporting sleeve.

Further, according to a preferred aspect of the present invention, the fixing ring comprises two axial ends, and the fixing ring in its fixing state comprises a constriction between its two axial ends, and/or is radially inwardly bent over at at least one of its axial ends. These configurations of the fixing ring are advantageous when the fixing ring is supported by a fixing body holding sleeve surrounding the outside of the end of the pipe to be connected. When the fixing ring engages the inside of the end of the pipe to be connected, the shape of the fixing ring may be an inversion of the two aforementioned alternatives.

In particular one or more of the following alloys are used for a shape memory metal alloy: NiTi alloys, NiTi—X alloys (where X may be Nb, for example), CuZnAl alloys, Cu—AlNi alloys, Ag—Cd, Au—Cd, Cu—Zn, Cu—Sn, In—Ti, Ni—Al, Fe—Pt, Mn—Cu, Fe—Mn—Si.

Thus, according to the present invention, a pipe to be connected to a fitting is fixed with the aid of a reversibly deformed fixing element which returns into its original shape due to thermal activation (fixing state), and in this state produces a non-positive connection between the fitting body and the pipe. Shape memory metal alloys are generally known such that individual material compositions of the alloys and their deformation from an original shape (fixing state) into a different shape (non-fixing state), from which they are capable of returning into their original shape again due to thermal activation, need not be described here.

### BRIEF DESCRIPTION OF THE DRAWINGS

Various embodiments of the invention will now be described in greater detail with reference to the drawings in which:

FIGS. 1 and 2 show half sections of a fitting for a plastic pipe, wherein the fixing element is in its non-fixing state (FIG. 1) and in its fixing state (FIG. 2), respectively,

FIGS. 3 and 4 show half sections of another embodiment of a fitting for a pipe, wherein the fixing element is in its non-fixing state (FIG. 3) and in its fixing state (FIG. 4), respectively,

FIGS. 5 and 6 show half sections of another embodiment of a fitting for a pipe, wherein the fixing element is in its non-fixing state (FIG. 5) and in its fixing state (FIG. 6), respectively, and

FIGS. 7 and 8 show half sections of another embodiment of a fitting for a pipe, wherein the fixing element is in its non-fixing state (FIG. 7) and in its fixing state (FIG. 8), respectively.

### DETAILED DESCRIPTION OF THE PREFERRED EMBODIMENTS OF THE INVENTION

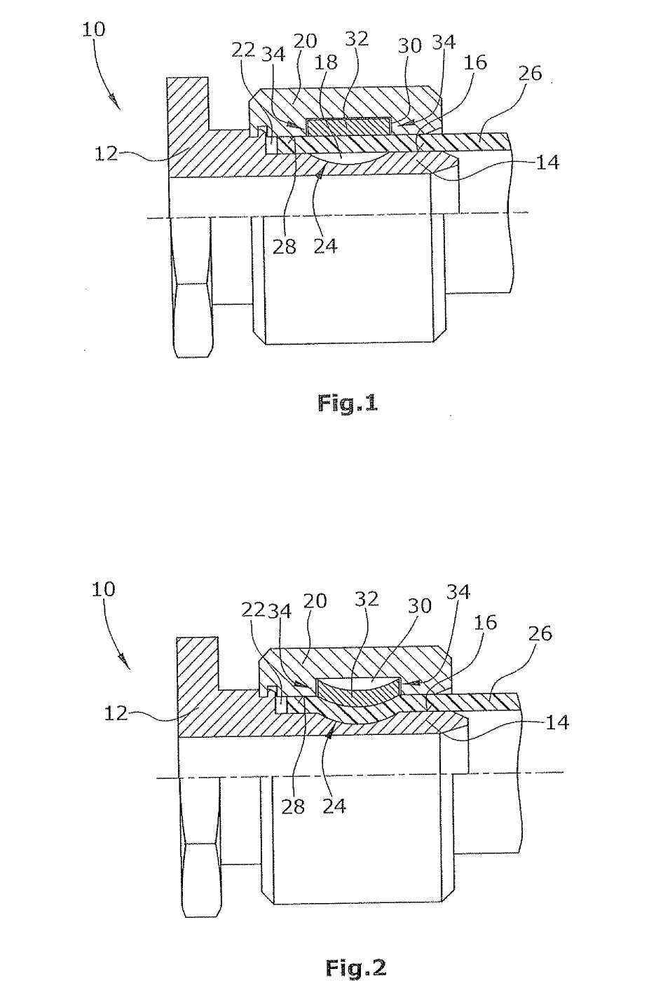

FIGS. 1 and 2 show half sections of a first embodiment of a fitting 10. The fitting 10 is made of a metal alloy or a plastic material or a plastic-metal composite material, for example, and comprises a fitting body 12 provided with a supporting sleeve 14. The supporting sleeve 14 is provided at its outside 16 with a recess 18 extending in circumferential direction of the supporting sleeve 14. A holding sleeve 20, which is also connected with the fitting body 12, is arranged concentrically with the supporting sleeve 14 and in spaced relationship thereto. The end 24 of a pipe 26 to be connected is adapted to be slid into a ring interspace 22 between the holding sleeve 20 and the supporting sleeve 14.

In the illustrated embodiment, the pipe 26 is a plastic pipe. Alternatively, the pipe may be made of a plastic-metal composite material.

At the inside 28 of the holding sleeve 20 a receiving recess 30 extending in circumferential direction for a fixing ring 32 is located, wherein in the illustrated embodiment said ring is configured as a band ring. The receiving recess 30 is arranged opposite the recess 18 in the supporting sleeve 14. The fixing ring 32 is made of a shape memory metal alloy. For example, any one of the metal compositions stated below can be used as an alloy: NiTi (nickel titanium; nitinol), CuZn (copper zinc), CuZnAl (copper zinc aluminum), CuAlNi (copper aluminum nickel), and FeNiAl (iron nickel aluminum).

For installing such a fitting 10, its fixing ring 32, in the martensite phase of the shape memory alloy, is mechanically transferred into a shape having a cross sectional area which is larger than the cross sectional area of the pipe 26 to be connected. This shape of the fixing ring 32 is maintained until the fitting 10 is used for connecting a pipe, wherein the pipe 26 is slid onto the supporting sleeve 14. Subsequent thermal activation (allowing the fixing ring 32 to heat up or heating the fixing ring 32 to a temperature at which the shape memory alloy of the fixing ring 32 is in its austenite phase) the fixing ring 32 is automatically returned into its initial state. In this initial state, the fixing ring 32 presses against the pipe 26 to be connected, whereby generally both the sealing function and the mechanical supporting function of the fitting 10 are fulfilled. It is possible to provide the fitting body 12 with a sealing element at its surface adapted to be brought in abutment to the pipe 26. The sealing element may be arranged at the fixing ring 32 shortly before thermal activation of the fixing ring 32; alternatively, the sealing element may already be disposed at the supporting sleeve 14.

In the situation shown in FIG. 1, the fixing ring 32 is in its non-fixing state in which it does not act upon the end 24 of the pipe 26 to be connected, and in which said end 24 is loosely inserted in the ring interspace 22. Thermal activation, i.e. heating of the fixing ring 32, causes the ring to assume its original shape, which is generally shown in FIG. 2. In this shape, i.e. the fixing state of the fixing ring 32, said ring is concavely deformed at its outside, i.e. it comprises a constriction between its axial ends 34. Said constriction causes the wall at the end 24 of the pipe 26 to connected received by the fitting 10 to be pressed into the circumferential recess 18 of the supporting sleeve 14, whereby the pipe 26 is fixed to the fitting 10.

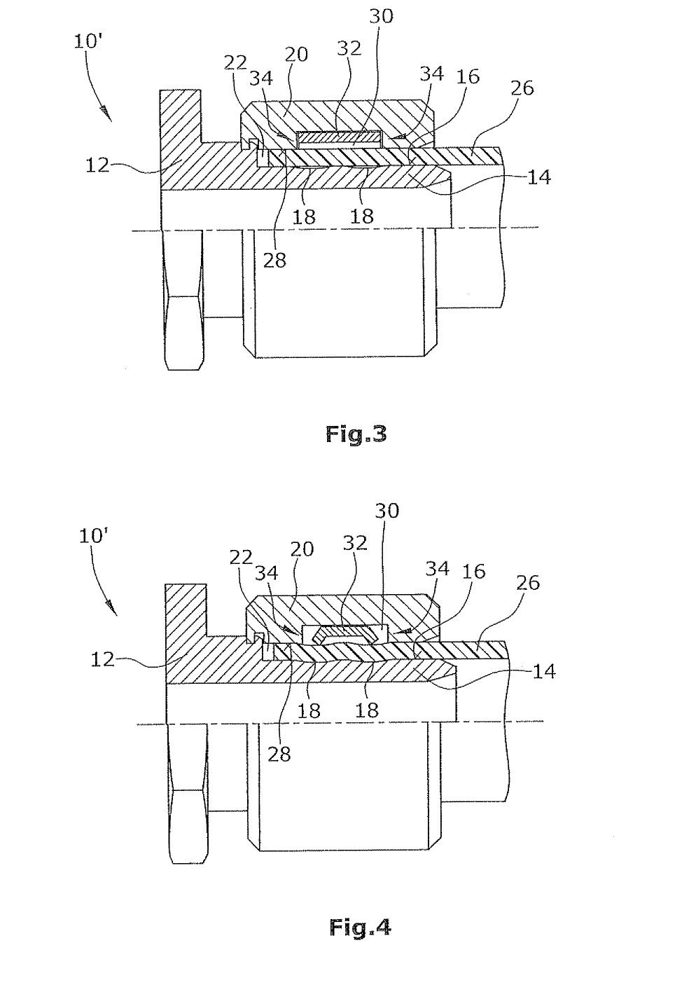

FIGS. 3 and 4 show an alternative fitting 10′ comprising a fixing ring 32 shaped in accordance with another embodiment of the present invention. Where the individual elements of the fitting 10′ of FIGS. 3 and 4 are identical in construction and function with the elements of fitting 10 shown in FIGS. 1 and 2, they are identified by the same reference numerals in FIGS. 3 and 4 as in FIGS. 1 and 2. The difference between the fitting shown in FIGS. 1 and 2 and that shown in FIGS. 3 and 4 is that the fixing ring 32 of the fitting 10′ is inwardly bent over at its axial ends 34 in the fixing state of said fixing ring, thus causing a deformation of the end 24 of the pipe 26 to be connected, which is pressed into recesses 18 of the supporting sleeve 14, as shown in FIG. 4.

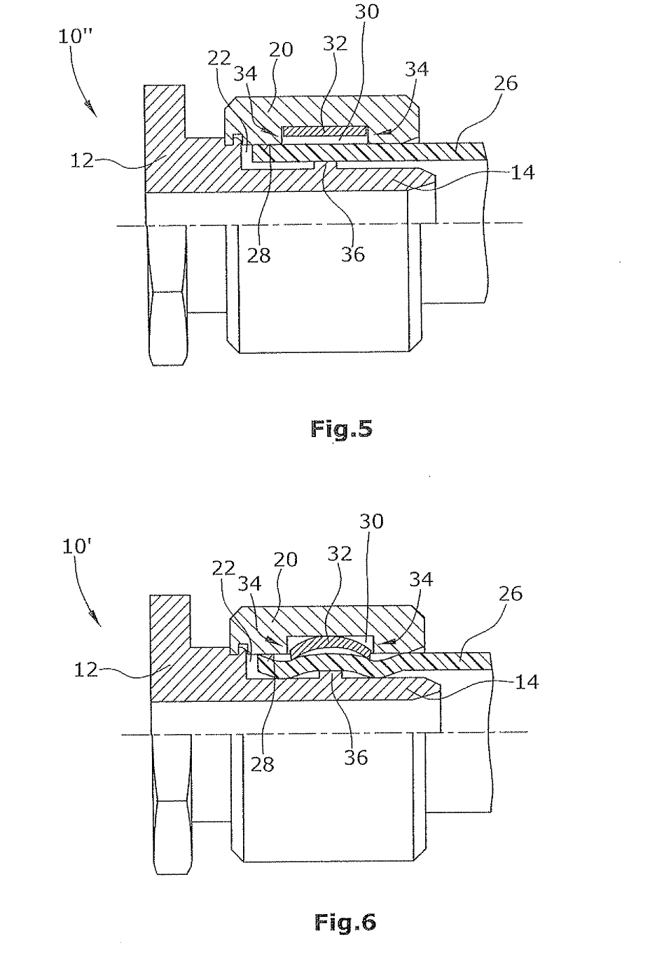

Another embodiment of a fitting 10″ comprising a fixing element made of a shape memory metal alloy is shown in FIGS. 5 and 6. Here, too, identical individual parts are identified by the same reference numerals.

In the embodiment shown in FIGS. 5 and 6 the supporting sleeve 14 comprises a circumferential projection 36 against which the fixing ring 32 presses the wall of the pipe 26 to be connected when the fixing ring 32 is in its fixing state shown in FIG. 6. In this fixing state, the fixing ring 32 is convex at its outside, i.e. it is concave at its inside.

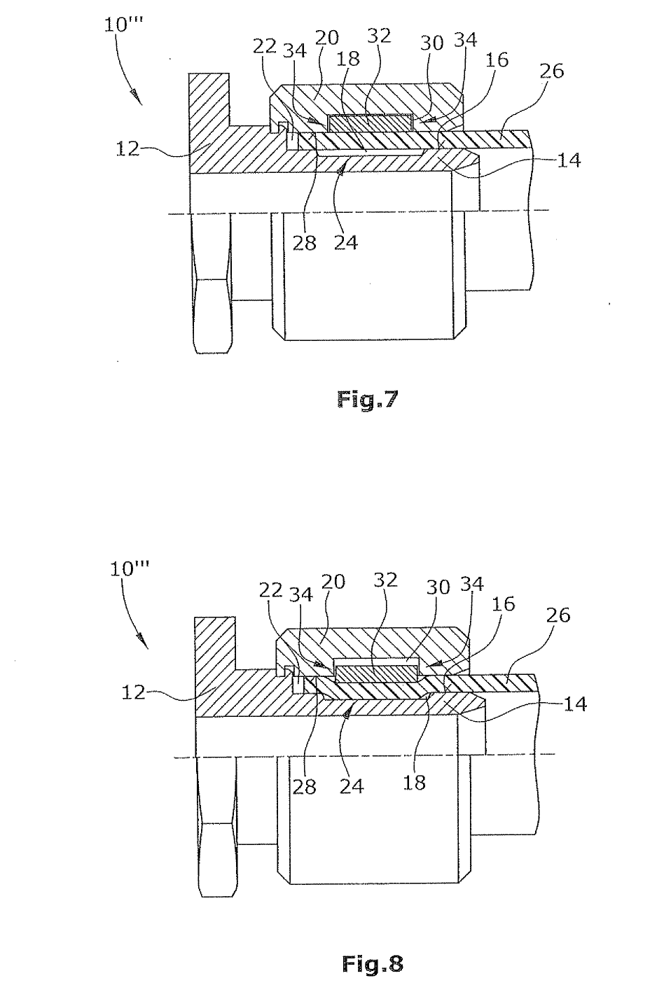

FIGS. 7 and 8 show a fourth embodiment of a fitting 10′″, wherein the fixing ring 32 made of a shape memory metal alloy radially contracts when in its non-fixing state to assume its fixing state. In this constricted state, the fixing ring 32 radially presses from outside against the pipe 26 to be supported, whereby the pipe 26 is pressed into a circumferential recess of the supporting sleeve 14 of the fitting body 12.

The present invention is described above on the basis of several exemplary embodiments, wherein the fixing element, i.e. the fixing ring 32, engages the pipe 26 to be connected from outside. It is to be understood, however, that the fixing element may also be arranged at a portion of the fitting onto which the pipe to be connected is slid such that, in this fitting embodiment, the fixing ring or the fixing element engages the wall of the pipe to be connected from inside. In particular, the fixing element can be configured as a sleeve as in press fittings adapted to be pressed by pressing tools.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A fitting for a pipe, in particular a plastic pipe or a plastic-metal composite pipe, comprising
a fitting body for receiving an end of a pipe to be connected, and
a fixing element for fixing said end of said pipe to be connected to said fitting body,
wherein said fixing element comprises a shape memory metal alloy, and
wherein said fixing element is adapted to be deformed by thermal activation from a non-fixing state in which said end of said pipe to be connected is received by said fitting body without being fixed, into a fixing state in which said end of said pipe to be connected is fixed to said fixing body.

2. The fitting according to claim 1, wherein the fitting body comprises a supporting sleeve onto which the end of the pipe to be connected is adapted to be slid, and said supporting sleeve comprises at its outside a recess into which the fixing element presses a recess-spanning portion of said end of said pipe to be connected, thereby deforming said end.

3. The fitting according to claim 1, wherein the fitting body comprises a supporting sleeve onto which the end of the pipe to be connected is adapted to be slid, the supporting sleeve comprises a projection at its outside, and the fixing element in its fixing state presses a projection-spanning portion of said end of said pipe to be connected against said supporting sleeve at least at a side of said projection facing away from a free end of said supporting sleeve, thereby deforming said end.

4. The fitting according to claim 1, wherein the fixing element is supported at an inside of a holding element which surrounds the end of the pipe to be connected received by the fitting body.

5. The fitting according to claim 4, wherein the fixing element in its fixing state is supported by the holding element.

6. The fitting according to claim 1, wherein the fixing element is a fixing ring.

7. The fitting according to claim 6, wherein the fixing ring comprises two axial ends, and the fixing ring in its fixing state comprises a constriction between its two axial ends.

8. The fitting according to claim 1, wherein the fixing ring comprises two axial end, and the fixing ring in its fixing state is radially inwardly bent over at one of its axial ends.

9. The fitting according to claim 1, wherein the fixing element is configured as a sleeve for surrounding an end of the pipe to be connected slid onto a supporting sleeve of the fitting body.

10. The fitting according to claim 1, wherein a shape memory metal alloy is selected from the group comprising: NiTi alloys, NiTi—X alloys (where X may be Nb, for example), CuZnAl alloys, Cu—AlNi alloys, Ag—Cd, Au—Cd, Cu—Zn, Cu—Sn, In—Ti, Ni—Al, Fe—Pt, Mn—Cu, Fe—Mn—Si.
